(19) United States
(12) Patent Application Publication
(10) Pub. No.: US 2025/0379739 A1
(43) Pub. Date: Dec. 11, 2025

(54) REMOTE EXECUTION VERIFICATION WITH REDUCED RESOURCE REQUIREMENTS

(71) Applicants: NTT Research, Inc., Sunnyvale, CA (US); Technion Research & Development Foundation Limited, Haifa (IL)

(72) Inventors: Justin HOLMGREN, Boston, MA (US); Ron ROTHBLUM, Haifa (IL)

(73) Assignees: NTT Research, Inc., Sunnyvale, CA (US); Technion Research & Development Foundation Limited, Haifa (IL)

(21) Appl. No.: 18/878,062

(22) PCT Filed: Jun. 22, 2023
(86) PCT No.: PCT/US2023/068903

§ 371 Date: Dec. 22, 2024

Related U.S. Application Data
(60) Provisional application No. 63/354,599, filed on Jun. 22, 2022.

(51) Int. Cl. H04L 9/32; H03M 13/15

(52) U.S. Cl. CPC H04L 9/3221; H03M 13/1515

(57) ABSTRACT

A method and apparatus for efficient protocols for verifying remote computations, with particular application for cloud-based services and mobile environments are disclosed. The protocols utilize succinct arguments that rely on the existence of subexponentially secure linear-size computable collision-resistant hash functions. The class of Boolean circuits that can be handled includes circuits with a repeated sub-structure, which arise in natural applications such as batch computation/verification, hashing, and related block chain applications.

### CROSS-REFERENCE TO RELATED APPLICATION

This application claims the benefit of U.S. Provisional Application Ser. No. 63/354,599 filed Jun. 22, 2022, the content of which is incorporated by reference herein in its entirety.

### FIELD OF THE INVENTION

The invention relates to efficient protocols for verifying remote computations, with particular application for cloud-based services and mobile environments.

### BACKGROUND OF THE INVENTION

Succinct arguments are interactive proof systems that allow a prover to convince a verifier that a computational statement is true, using an extremely short proof. Soundness is computational—no polynomial-time cheating prover can convince the verifier to accept a false statement except with negligible probability.

Succinct arguments, especially those that are zero-knowledge, originate in the pioneering theoretical works of Kilian and Micali. In recent years however they have been drawing immense interest also in practice and several different systems are being developed and deployed. One of the major bottlenecks to more widespread deployment is the overhead incurred by the prover—the cost of proving that a statement is true is still orders of magnitude larger than directly checking that the statement is true.

The original work of Kilian, based on PCPs and collision resistant hash functions, has a prover that has a large polynomial overhead. Since Kilian's original work, and especially in recent years, there has been significant effort in improving the prover's runtime. In particular, a recent line of works have achieved succinct arguments with a linear-size prover for arithmetic circuits over large finite fields. Even more recently, Ron-Zewi and Rothblum constructed succinct arguments with a strictly linear-size prover for general Boolean circuits. However, the soundness error in their protocol is constant, rather than negligible as we would typically desire. All of these results fall short of the holy-grail in the field, which is captured by the following question:

$$Can we contruct succinct arguments and interactive oracle proofs for size \text{} - \text{} S circuits with an O ( S ) + poly ( λ ) size prover and soundness error {2}^{- λ ?}$$

We emphasize that straightforward repetition, or working over 2^{λ}-size finite fields, yields an O(S·λ)-size prover (when implemented as a Boolean circuit). The challenge that we are faced with is therefore breaking the multiplicative dependence between the circuit size and the security parameter into an additive one.

The general question of constructing cryptographic primitives with constant overhead was raised by Ishai et al., In particular, they asked whether we can construct zero-knowledge proofs (with negligible soundness error) and constant computational overhead for the prover.

As was previously mentioned, a recent exciting line of work has constructed succinct arguments for arithmetic circuits over large finite fields, with a linear-size prover for a more through discussion and comparison of some of these works). In the Boolean circuit regime, the best result achieves a linear-size prover, albeit with only a constant soundness error.

A separate line of work has focused on constructing zero-knowledge proofs with a linear-size prover, but where the communication may also grow linearly in the circuit size. (Here the aspect that makes the problem non-trivial is simply that the proof should be zero-knowledge.) Such a non-succinct zero-knowledge proof, with a linear-size prover, can be derived fairly directly using linear-size computable commitments, but the resulting proof-system has a constant soundness error.

Damgård et al. similarly construct non-succinct zero-knowledge proofs with comparable prover size to ours—namely, |C|-polylog(λ). We emphasize however that that protocol is not succinct.

Recent works by Weng et al. and Franzese et al. also construct non-succinct zero-knowledge proof (with sub-constant soundness error), where the prover can be implemented as a linear-time RAM program. Others have constructed zero-knowledge proofs for arithmetic circuits with constant overhead.

A separate line of work focuses on the space efficiency of the prover. Proof-systems achieving time and space efficient provers are known in the designated verifier setting as well as in the publicly verifiable setting. Other work achieves highly efficient parallel time.

### BRIEF SUMMARY OF THE INVENTION

Succinct arguments allow a prover to convince a verifier that a given statement is true, using an extremely short proof. A major bottleneck that has been the focus of a large body of work is in reducing the overhead incurred by the prover in order to prove correctness of the computation. By overhead we refer to the cost of proving correctness, divided by the cost of the original computation.

In this work, for a large class of Boolean circuits C=C(x, w), we construct succinct arguments for the language {x: [symbol] w C(x, w)=1}, with 2^{-λ} soundness error, and with prover overhead polylog(λ). This result relies on the existence of (sub-exponentially secure) linear-size computable collision-resistant hash functions. The class of Boolean circuits that we can handle includes circuits with a repeated sub-structure, which arise in natural applications such as batch computation/verification, hashing and related block chain applications.

The succinct argument is obtained by constructing interactive oracle proofs for the same class of languages, with polylog(λ) prover overhead, and soundness error 2^{-λ}. Prior to our work, the best IOPs for Boolean circuits either had prover overhead of polylog(|C|) based on efficient PCPs due to Ben Sasson et al. (STOC, 2013) or poly(λ) due to Rothblum and Ron-Zewi (STOC, 2022).

Some embodiments of the invention include systems, methods, network devices, and machine-readable media for certifying that a computation of at least one executable instruction is performed correctly at a computerized processor, including by:
receiving an algorithmic representation of a computation to be verified, the computation being of a type;
receiving a desired soundness error parameter;
translating the computation into a matrix representation including matrices A, B, C, X, each of which is a sum of tensor products of a constant number of smaller matrices;
wherein the matrices A, B, C, X represent the computation;
wherein part of a description of the matrices includes a decomposition of the matrices;
both a verifier and a prover storing an input string x, wherein x is dependent on or associated with the type of computation;
storing at the prover an input string z, wherein x and z are related to each other by X·z=x, wherein · denotes matrix-vector multiplication, and a pointwise Hadamard product of (A·z) and (B·z) is (C·z);
executing a protocol by:
   1. at the prover, computing and transmitting digests of z, A·z, B·z, C·z;
2. for each constraint a′=A·z′, b′=B·z′, c′=C·z′, x′=X·z′, and the constraint that c′ is the pointwise Hadamard product of a′ and b′, and wherein z′, a′, b′, c′ denote the values of which the prover transmitted digests:
executing a sub-protocol, the sub-protocol comprising:
   a. at the verifier:
      i. representing the constraint as multiple smaller constant-degree constraints, each of the smaller constraints involving a constant number of intermediate vectors;
      ii. deriving from each of these smaller constraints multiple extended constraints, of the same form, on a linear encoding of the intermediate vectors with a property of:
         1. if the constraint was satisfied, then all of these extended constraints can be satisfied;
         2. otherwise, at most a constant fraction of them can be satisfied;
      b. at the prover:
         i. transmitting to the verifier encodings of the intermediate vectors;
      c. at the verifier:
         i. for each of the smaller linear constraints, uniformly sampling multiple derived extended constraints; and
         ii. checking that each of the sampled derived extended constraints is satisfied; and
   3. at the verifier, outputting a positive result if and only if the checking that each of the sampled derived extended constraints is satisfied.

In some further embodiments, the prover transmits a compressed version of each message, and at the verifier, verifier accesses to the uncompressed messages are replaced by a local opening protocol between the prover and the verifier.

In some further embodiments, the intermediate vectors are specified as:
z₀=z, z₁, . . . , zₘ=a such that, where each constraint either has the form:
   zᵢ=zⱼ+zₖ for some integers i, j, k between 0 and m inclusive; or
   zᵢ=Aᵢ·zⱼ for a matrix Aᵢ that is a tensor product of identity matrices with one of the smaller matrices comprising A.

In some further embodiments, the compressed version is compressed by a succinct vector commitment or a hash tree.

In some further embodiments, the prover is possibly dishonest.

### BRIEF DESCRIPTION OF THE DRAWINGS

The accompanying drawings, which are included to provide further understanding and are incorporated in and constitute a part of this specification, illustrate disclosed embodiments, and together with the description, serve to explain the principles of the disclosed embodiments. In the drawings:

FIG. 1 illustrates an example protocol operating between a prover and a verifier for implementing the claimed systems and methods.

FIG. 2 illustrates an example computer system architecture for implementing the claimed systems and methods.

FIG. 3 illustrates further details of an example computer system architecture for implementing the claimed systems and methods.

### DETAILED DESCRIPTION

In this disclosure, we construct succinct arguments for resolving the above question, for a large class of Boolean circuits. The first main result is a succinct argument-system with a |C|·polylog(λ)+poly(λ, log|C|)-size prover, for the relevant class of circuits C. This result relies on the existence of linear-size computable hash functions such as those constructed by Applebaum et al.

Theorem 1 (Informally Stated, see Theorem 4). Assume the existence of sub-exponentially secure linear-size computable hash functions.

Then, for any Boolean circuit C: {0, 1}^{n+m}→{0, 1} of size S with a “nice” succinct description of size s, there exists a succinct public-coin argument for the language {x∈{0, 1}ⁿ: [symbol] ∈{0, 1}^{m}, C(x, w)=1}, with 2^{-λ} soundness error and an S·polylog(λ)+poly(λ, log S) size prover. The communication complexity is poly(λ, log S), the number of rounds is O(log S) and the verifier runs in time O(n+s·λ).

We emphasize that the main novelty in Theorem 4 is that the prover has size roughly S·polylog(λ), rather than S·poly(λ). The “nice” class of circuits that we handle generalizes (modulo minor technicalities) the notion of Succinct R1CS, introduced by Ben Sasson et al., Succinct R1CS was defined as a constraint system involving two types of constraints: time constraints and boundary constraints. We can always handle the time constraints, and handle natural boundary constraints, which were the motivation for the succinct R1CS definition. Loosely speaking, this class captures computations that have some repeated sub-structure. As the precise definition is somewhat involved and quite general (see Definition 6) we highlight two particular examples of interest. The first is “T-iterated” circuits for T≥λ, i.e. those which map z=(x, w) to

$${\underbrace{( D ∘ ⋯ ∘ D )}}_{T times} ( z )$$

for a small circuit D. The second is “batch” circuits, which map (z₁, . . . , z_{T}) to D(z₁)∧ . . . ∧D(z_{T}), again for T≥λ. In both cases, for any ε>0, we obtain a protocol where our prover has size T·|D|·polylog(λ) and our verifier has size (|D|+T^{ε})·poly(λ). We remark that these class of computations arise in natural scenarios involving cryptographic hashing and blockchains.

Following a body of recent works, Theorem 1 follows (non-trivially) from an analogous (unconditional) interactive oracle proof (IOP). An IOP can be thought of as an interactive version of a PCP—the prover can interact with the verifier, who in turn is allowed to read a few bits from each message sent by the prover. Our main technical result is a new efficient IOP construction for the same class of problems.

Theorem 2 (Informally Stated, see Theorem 3). For the same family of Boolean circuits C: {0,1}^{n+m}→{0,1} of size S with a “nice,” succinct description of size s, there exists an IOP for the language {x∈{0, 1}ⁿ: [symbol] w∈{0, 1}^{m}, C(x, w)=1}, with 2^{-λ} soundness error and an S·polylog(λ) size prover. The number of rounds is O(log S), the query complexity is s·poly(λ) and the verifier runs in time n·polylog(λ)+s·poly(λ).

We note that there are two aspects that make the compilation of the IOP of Theorem 2 into the succinct argument of Theorem 1 non-trivial. The first is the fact that the query complexity in Theorem 2 has an s dependence which may be only slightly sublinear in S, whereas the communication complexity in Theorem 1 has a poly-logarithmic dependence on S. This improvement is actually relatively easy to achieve—we first construct an argument-system in which the communication complexity is s·poly(λ) but then compose with an off-the-shelf argument-system to reduce the communication to be polylogarithmic. (We remark that we leave open the question of improving the verification time and query complexity to be poly-logarithmic in the IOP of Theorem 2.)

A more subtle, and serious, issue is that in order to implement the standard transformation of IOPs into succinct arguments the prover needs to be able to project its IOP messages to the specific verifier query locations. The straightforward circuit for projecting a string of length N=S·polylog(λ) to q coordinates, has size O(N·q) which we cannot afford. To the best of our knowledge no circuit of size O(N)+poly(q, log N) is known for the problem, which poses a serious difficulty. In prior work, this problem was overcome by ensuring that the verifier makes only a constant number of queries to each message (or reads it entirely). In our IOP since we are aiming for 2^{-λ} soundness error, intuitively, the verifier has to make Ω(λ) queries and so we cannot follow the prior approach. Rather, we overcome the difficulty by ensuring a utilizing a particular query structure of our IOP verifier, as described herein.

### 1 Technical Overview

Multi-sumcheck with Small Error. protocol. Generally speaking, a multi-sumcheck IOP is an IOP in which the verifier is given oracle access to a pair of codewords c, c′, belonging to a code C: [symbol] → [symbol] , and would like to compute the inner product Σ_{i∈[k]}c(i)·c′(i). For simplicity, we focus here on the case of two codewords, but in general we can handle any constant number of codewords. Ron-Zewi and Rothblum construct a linear-size encodable code C which has a multi-sumcheck protocol with a linear-size prover. Unfortunately, the protocol only has a constant soundness error.

We first discuss two common approaches for error reduction. The first is simply to repeat the protocol O(λ) times. This indeed reduces the soundness error at an exponential rate, but naturally increases the prover's size by a λ multiplicative factor, which we would like to avoid. Another common approach is to try to work with codes with very large minimal distance, say 1−2^{-λ}. Unfortunately, by the Plotkin bound, such codes require an exponentially-large alphabet which would again introduce a poly(λ) multiplicative factor in runtime.

Thus, we develop a method for reducing the soundness error of the protocol to 2^{-λ}, but with only a polylog(λ) overhead in the prover's size.

Let [symbol] be a finite field of size O(λ) and consider the Reed-Solomon code RS_{λ}: [symbol] → [symbol] ^{(λ}) over [symbol] —namely, the code consisting of all degree λ−1 polynomials over | [symbol] |. We will use two key properties of the Reed-Solomon code: (1) that it is a multiplication code (since the point-wise (aka Hadamard) product of any two polynomials is a polynomial of degree at most 2λ and therefore belongs to a closely related Reed-Solomon code) and (2) that it can be encoded by a size λ·polylog(λ) circuit (using the Fast Fourier Transform). We remark that the parameters (in particular the field size and block length) are set so that RS_{λ} has a constant relative distance and further note that we could replace the Reed-Solomon code with any constant-distance multiplication code with quasi-linear time encoding.

In addition to the ubiquitous Reed-Solomon code, we will also use a code C. Indeed, we will combine these two codes to construct a new code D and show an efficient multi-sumcheck procedure for D with a small soundness error.

The code D is simply the tensor product of RS_{λ} with C, denoted D=C⊗RS_{λ}. In this code, messages are viewed as (k/λ)×λ matrices and we encode them by encoding first the rows using RS_{λ} and encode the columns (both old and the new ones generated by the row encoding) using C (where we use C with respect to message size k/λ). Any issues of alphabet size can be resolved by a simple extension to a larger alphabet size, while accounting for additional polylog( [symbol] ) factors in efficiency, which we can afford since | [symbol] |=O(λ). Observe that since RS_{λ} is encodable by a λ·polylog(λ)-size circuit, and C is encodable by a linear-size circuit, the code D is overall encodable by a circuit of size (k/λ)·λ·polylog(λ)+O(λ)·O(k/λ)=k·polylog(λ). Thus, the code D maps messages of length k to codewords of length k·polylog(λ) and is encodable by a k·polylog(λ) size circuit.

Our first main step is showing a multi-sumcheck protocol for D, with soundness error 2^{-λ}. Recall that the input to this protocol is two codewords d, d′∈D, and we would like to check that Σ_{i∈[k/λ]j∈[λ]}d(i, j)·d′(i, j)=b, for some scalar b. The protocol is simple—the prover generates the codeword dₛᵤₘ∈RS_{2λ} (we use R_{2λ} to denote the Reed-Solomon code of the same block length as RS_{λ} but double the degree) defined as dₛᵤₘ=Σ^{i∈[k]}dᵢ ★dᵢ′, where dᵢ and dᵢ′ denote the i-th rows of d and d′, respectively, and ★ denotes a point-wise/Hadamard product. Note that by linearity, dₛᵤₘ is indeed a codeword of RS_{2λ} and that Σⱼdₛᵤₘ(j)=Σ_{i,j}d(i, j)·d′(i, j). The prover computes dₛᵤₘ and sends it explicitly to the verifier. The verifier in turn, after receiving the message \tilde{d}ₛᵤₘ (which may or may not be equal to the intended dₛᵤₘ) checks that \tilde{d}ₛᵤₘ∈RS_{2λ} and that Σ_{j∈[λ]}\tilde{d}ₛᵤₘ(j)=b.

Thus, if the original claim is false, in order not to be caught already at this stage, the prover must send a false codeword \tilde{d}ₛᵤₘ≢dₛᵤₘ.

At this point we observe that \tilde{d}ₛᵤₘ and dₛᵤₘ are distinct codewords and so they must disagree on a constant fraction of their coordinates.

In more detail, denote the set of coordinates on which dₛᵤₘ and \tilde{d}ₛᵤₘ differ by J⊆[O(λ)]. That is,

$$J = \{ j : {\tilde{d}}_{s u m} ( j ) \neq {d}_{s u m} ( j ) = {\sum }_{i ∈ [ k / λ ]} d ( i , j ) \cdot {d}^{′} ( i , j ) \} .$$

Recall that by the above arguments, we know that |J|=O(λ). At this point we run the multi-sumcheck protocol of Ron-Zewi and Rothblum, with a constant soundness error, on each and every coordinate j to check that Σ_{i∈[k/λ]}d(i, j)·d′(i, j)=\acute{d}ₛᵤₘ(j). The cost of each invocation is O(k/λ), and we have O(λ) such invocations, leading to an overall cost of O(k). In terms of soundness, for each j∈J, the probability that the verifier accepts in the underlying multi-sumcheck is at most a constant and so the probability that it accepts for all j∈J is 2^{-λ}, as desired.

In prior works, such as Ron-Zewi and Rothblum, the multi-sumcheck was the key component and other protocols follows in a straightforward manner. Unfortunately, in our parameter regime this is no longer the case.

To demonstrate this, consider the following related task that arises often in the construction of IOPs. Suppose we are given access to a codeword c and want to check that the first k′ bits of c are identically 0. A common approach for doing so is to have the verifier choose at random (or pseudorandomly) a vector r∈{0, 1}^{k′} and to run multi-sumcheck on the expression Σ_{i∈[k′]}rᵢ·cᵢ=0. The point is that if the claim is false (i.e., cᵢ≠0 for some i∈[k′]) then the above sum will still be zero with probability that is inversely proportional to the field size | [symbol] |. In all prior works that we are aware of, this sufficed since the goal was to have error probability 1/ [symbol] |. In contrast, in this work we want to simultaneously work over a field of size polylog(λ) but to have soundness error 2^{-λ}. We manage to solve this difficulty by taking an approach that is similar to, but somewhat more complicated than, our approach for handling the multi-sumcheck protocol.

At a high level, we again view c as a tensor codeword. Using the efficient Reed-Solomon encoding, we can transform c into a new codeword c′ so that if c was non-zero in even one coordinate in [k′], then c′ is non-zero in many of its columns. We can then check each and every one of the columns using Ron-Zewi and Rothblum, each with a constant error probability, to overall get a 2^{-λ} error probability.

A Difficulty with Arithmetization. With a toolkit of efficient IOP sub-protocols in hand, it now seems straightforward to use existing ideas from the literature to construct an IOP for NP. Unfortunately, this turns out to be more complicated than expected. To explain the difficulty, let us focus on a specific NP complete problem which is particularly “arithmetization friendly”, called R1CS (for Rank 1 Constraint Satisfiability). We view the problem as being parameterized by three (sparse) square matrices A, B and C and a given input x belongs to the language if there exists w such that Az★Bz=Cz, where z=(x, w).

The typical way to arithmetize the problem is for the prover to send encodings of z, a=Az, b=Bz and c=Cz and run sub-protocols to check that:

$$- a ⋆ b = c .$$

$$- a = Az , b = Bz and c = C z .$$

The first check can be handled using the multi-sumcheck and related techniques and so we do not elaborate on this point. The latter check however turns out to be more complicated.

Let us see the difficulty in trying to employ a standard approach: the verifier chooses a random (or pseudorandom) vector r to reduce checking that a=Az to checking that:

$${\sum }_{i} {r}_{i} {a}_{i} = {\sum }_{i} {{r}_{i} ( A z )}_{i} = {\sum }_{i} {( {r}^{T} A )}_{i} {z}_{i}$$

and now the two sides of the equation can be computed by employing the multi-sumcheck protocol. The problem that we encounter is that a single execution of this approach only has a constant soundness error (if we are working over a small field). Our techniques for boosting the soundness that worked for multi-sumcheck seem to fail because the matrix A is arbitrary which precludes attempts at decomposing the problem into smaller sub-problems.

Rather than handling arbitrary matrices A, we restrict our attention to matrices that have a specific structure. In particular, we start by considering matrices of the form A=Iₖ ⊗A₀, where Iₖ is the k×k identity matrix and A₀ is a small matrix, say of size s×s. Intuitively, we can think of A as acting on k×s matrices, such that if y=A(x), then each row of y is obtained from the corresponding row of x by applying A₀. If x and y are column-wise encoded with a fixed linear code C, then we can say the same thing for the encodings \hat{x} and ŷ of x and y respectively: each row of ŷ is obtained from the corresponding row of \hat{x} by applying A₀.

Now if C has constant relative distance, the verifier given \hat{x} and ŷ has a way to succinctly check, with low soundness error, whether y=Ax: the verifier samples λ random rows of \hat{x}, along with the corresponding rows of ŷ, and checks that the latter are obtained from the former by applying A₀. If y≠Ax, then the distance of C implies that at least a constant fraction of the rows of ŷ are incorrectly generated, and so the verifier will reject with probability 2^{-Ω(λ)}. Note that the size of this verifier is O(λ·s²), which can be much smaller than the number of entries of A (which is k²·s²).

We can push this simple idea quite far. Instead of viewing A as acting on matrices, we view A as acting on degree-d tensors, and instead of column-wise encodings we use tensor codes. This immediately allows us to handle matrices A of the form A₁⊗ . . . ⊗A_{d}. We can also handle sum of such matrices, and in fact we give a more general notion of matrices A that are computable by a new notion that we introduce called “succinct tensor circuits” (see Definition 6). As described herein, this notion generalizes (modulo some technicalities) the notion of succinct R1CS.

The Projection Problem. We turn to discussing an additional subtle difficulty that we encounter when attempting to compile our IOP into an efficient argument, as described herein. The common approach for compiling an IOP is for the prover to send Merkle hashes of each of its messages and, at the end of the protocol, to send authentication paths corresponding to the verifier's desired queries.

The problem is that projecting the proof string to the desired query locations may, in general, introduce overhead. This naturally raises the following question: can we construct a “multi-plexing” circuit of size O(N)+poly(k, log N) that given a string x∈{0, 1}^{N} (in our case the IOP string) and a set Q⊆[N] (i.e., the verifier's queries) of size k, outputs x_{Q}. Note that for our purposes we cannot afford a circuit of size Ω(N·k) for this task, and even a circuit of size Ω(N·log(N)) would be too much.

Unfortunately, we do not know how to solve the above task in general with the desired complexity. Imagine though, that we had a promise that the query set Q has a nice structure—namely, that we can partition the input x into N/k blocks and that the first query in Q is to block 1, the second is to block 2 and so forth. In such a case, we could just concatenate k simple multi-plexing circuits each of size O(N/k) to solve the problem and get, overall, a circuit of size O(N).

Unfortunately, typical IOPs have a highly random query pattern. For example, one of the tasks that we often have to do is sample some O(λ) coordinates of a given codeword c (from a code with constant relative distance) so that we can guarantee that with probability 1−2^{-λ} at least one of the entries is non-zero.

Our observation, is that the random sampling of k=O(λ) points can indeed be replaced in this case by partitioning the codeword into blocks of N/k and choosing just a single point in each block! While this distribution is far from the uniform distribution over [n]^{k}, it is easy to show that it still solves our sampling task with an exponentially small error probability. We extend this approach to all of the verifier's tests to obtain an IOP for which we can indeed efficiently project the IOP messages to the verifier's query set.

### 2 Preliminaries

### 2.1 Notation and Conventions

Throughout this paper we use the notion of a Boolean circuit. When we refer to the size of a circuit, we use the usual meaning (the number of gates). We emphasize that we count input wires as gates, so that a circuit defined with an n-bit input will always have size at least n. This convention simplifies the statement of our results.

### 2.2 Probability

We use the following Chernoff bound.
Fact 1 (Chernoff). If X₁, . . . , Xₙ are independent {0, 1}-valued random variables and if μ denotes the expected value of ΣᵢXᵢ, then for all 0≤δ≤1,

$$Pr [ {\sum }_{i} {X}_{i} \leq ( 1 - δ ) \cdot μ ] \leq {e}^{- \frac{{δ}^{2} μ}{2}} .$$

### 2.3 Constructible Finite Fields

We will assume that all fields that we work with are constructible.
Definition 1. A field ensemble [symbol] = [symbol] is constructible if field elements can be represented using O(log( [symbol] )) bits and field operations (i.e., addition, subtraction, multiplication, inversion and sampling random elements) can be performed using a Boolean circuit of size polylog(| [symbol] |).
Fact 2. For every S=S(n)≥1, there exists a constructible field ensemble ( [symbol] where each [symbol] has characteristic 2 and size ⊖(S(n)).

### 2.4 Error-Correcting Codes

Let Σ be a finite alphabet, and k, n be positive integers (the message length and the codeword length, respectively). An (error-correcting) code is an injective map C: Σ^{k}→Σⁿ. The elements in the domain of C are called messages, and the elements in the image of C are called codewords. We say that C is systematic if the message is a prefix of the corresponding codeword, i.e., for every x∈Σ^{k} there exists z∈Σ^{n-k} such that C(x)=(x, z).

The rate of a code C: Σ^{k}→Σⁿ is the ratio

$$ρ := \frac{k}{n} .$$

The relative distance dist(C) of C is the maximum δ>0 such that for every pair of distinct messages x, y∈Σ^{k} it holds that dist_{Σ}(C(x), C(y))≥δ.

If Σ= [symbol] for some finite field [symbol] , and C is a linear map between the vector spaces [symbol] and [symbol] then we say that C is linear. The generating matrix of a linear code C: [symbol] → [symbol] is a matrix G∈ [symbol] such that C(x)=G·x for any x∈ [symbol] .

### 2.4.1 Multiplication Codes

Definition 2. The Hadamard product of vectors x, y∈ [symbol] , denoted x★y, is the vector z∈ [symbol] whose i^{th} component is zᵢ=xᵢ·yᵢ.

If X and Y are subsets of [symbol] , we write X★Y to denote the set {x★y: x∈X, y∈Y}, and for integer t≥0 we define

$${X}^{⋆ t} = \{ \begin{matrix}\{ {1}^{n} \} & if t = 0 \\ X ⋆ {X}^{⋆ ( t - 1 )} & otherwise\end{matrix} .$$

### 2.4.2 Tensor Codes

A main ingredient in our constructions is the tensor product operation, defined as follows. Definition 3 (Tensor codes). The tensor product code of linear codes C: [symbol] → [symbol] and C′: [symbol] → [symbol] is the code C⊗C′: [symbol] → [symbol] , where the encoding (C⊗C′)(M) of any message M∈ [symbol] is obtained by first encoding each column of M with the code C, and then encoding each of the n resulting rows with the code C′.

Note that by linearity, the codewords of C⊗C′ are n×n′ matrices (over the field [symbol] ) whose columns belong to the code C, and whose rows belong to the code C′. It is also known that the converse is true: any n×n′ matrix, whose columns belong to the code C, and whose rows belong to the code C′, is a codeword of C⊗C′.

Definition 4. We say that a function ƒ: {0,1}ⁿ→{0, 1}^{m} is locally computable by a size S circuit if there is a size-S circuit that takes as input x∈{0,1}ⁿ and i∈[m] and outputs ƒ(x)ᵢ.

By the definition of the tensor product code, we have the following.

Claim 1. The following holds for any pair of linear codes C: [symbol] → [symbol] , C′: [symbol] → [symbol] .
1. If C, C′ can be encoded by Boolean circuits of sizes S, S′ respectively, then C⊗C′ can be encoded by a Boolean circuit of size n′·S+n·S′.
2. If C and C′ are locally computable by size S₀ and

$${S}_{0}^{′}$$

circuits, respectively, then:
   (a) There is a size

$${k}^{′} \cdot {S}_{0} + {S}_{0}^{′}$$

circuit whose input is a message m∈ [symbol] ⊗ [symbol] and an index i∈[n]×[n′] and whose output is (C⊗C′)(m)ᵢ.
(b) There is a size

$${S}_{0} + {S}_{0}^{′}$$

circuit that on input m∈ [symbol] , m′∈ [symbol] , and i∈[n]×[n′], outputs (C⊗C′)(m⊗m′)ᵢ.

For a linear code C: [symbol] → [symbol] , let C^{⊗0}:= [symbol] → [symbol] denote the identity function (i.e. the function computed by the 1×1 matrix [1]), and let and C^{⊗t} denote C⊗C^{⊗(t-1)} for any t≥1.

Finally, applying iteratively the above Claim 1, gives the following.

Claim 2. The following holds for any linear code C: [symbol] → [symbol] .
1. If C: [symbol] → [symbol] can be encoded by a Boolean circuit of size s, then C^{⊗t} can be encoded by a Boolean circuit of size tn^{t-1}s.
2. If each coordinate of C can be computed in time T₀, then:
   (a) For every t∈ [symbol] , there is a size O(k^{t-1}·T₀) circuit that takes as input m∈( [symbol] ^{⊗t} and i∈[n]^{t} and outputs C^{⊗t}(m)ᵢ.
   (b) For every t∈ [symbol] , there is a size O(t·T₀) circuit that takes as input m₁, . . . , mₜ∈ [symbol] and i∈[n]^{t} and outputs C^{⊗t}(m₁ ⊗ . . . ⊗mₜ)ᵢ.

### 3 Main Results

Our results are most naturally stated in terms of (a slight modification to the notion of) Rank-1 Constraint Satisfaction (R1CS) relations.
Definition 5 (R1CS). A Rank-1 Constraint Satisfaction (R1CS) relation over a field [symbol] is parameterized by matrices A, B, C∈ [symbol] and X∈ [symbol] , and is defined as the set

$${ℛ}_{R 1 CS}^{A , B , C , X} {=}^{def} \{ ( x , z ) ∈ {𝔽}^{n} \times {𝔽}^{N} : X \cdot z = x ∧ ( A \cdot z ) ⋆ ( B \cdot z ) = C \cdot z \} ,$$

where ★ denotes pointwise multiplication.

We define

$${ℒ}_{R 1 CS}^{A , B , C , X}$$

as the set

$$\{ x ∈ {𝔽}^{n} : ∃ z ∈ {𝔽}^{N} s . t . ( x , z ) ∈ {ℛ}_{R 1 CS} \} .$$

We remark that the standard definition of R1CS require x to be a prefix of z. Our definition can simulate the former by setting X to be the matrix that projects its length-N input to the first n coordinates.

We will focus on R1CS relations for which the matrices A, B, C, X defining the R1CS relation can be succinctly expressed as a “tensor circuit”.

Definition 6 (Tensor Circuits). We define a tensor circuit over [symbol] to be a triple C=((Vᵢ)_{i∈[N]}, (Lᵢ)_{i∈[g+1]}, (φᵢ)_{i∈[g]}), where each Vᵢ is a vector space over [symbol] , each Lᵢ is a subset of [N], and for every j∈[g], φⱼ is a linear function mapping ⊗_{i∈L}_{ⱼ}_{\L}_{ⱼ₊₁} Vᵢ⊗_{i∈L}_{ⱼ₊₁}_{\L}_{ⱼ} Vᵢ.

We associate C with a function ƒ₉∘ . . . ∘ƒ₁, where ƒᵢ represents a function corresponding to the i^{th} gate φᵢ, and is defined as

$$\begin{matrix}{f}_{i} : {⊗}_{j ∈ {L}_{i}} {V}_{j} \to {⊗}_{j ∈ {L}_{i + 1}} {V}_{j} \\ {f}_{i} = {φ}_{i} ⊗ {⊗}_{j ∈ {L}_{i} ⋂ {L}_{i + 1}} {Id}_{{V}_{j}} .\end{matrix} \qquad ( 1 )$$

Remark 1. In Definition 6, we take all tensor products to be indexed by an unordered set L. For example, each Lᵢ is an unordered set and yet we consider the tensor product ⊗_{j∈L}_{ᵢ} Vᵢ. This reflects the fact that many aspects of the “ordering” of wires in (a layer of) a circuit are arbitrary and only serve to complicate notation. For example, when applying a gate φ to the i^{th} and j^{th} wires of a layer, it shouldn't matter whether i=1 and j=2, or if i=3 and j=5. However, if we force the usual ordered semantics, then only the former has the clean notation φ⊗Id. What we are doing with the above notation is implicitly specifying which wires φ is applied to via the domain of φ.
Definition 7 (Tensor Circuit Parameters). If C=((Vᵢ)_{i∈[N]}, (Lᵢ)_{i∈[g+1]}, (φᵢ)_{i∈[g]}) is a tensor circuit, we define the following important parameters of C:
Width: max_{i∈[g+1]}Π_{j∈L}_{ᵢ} dim(Vⱼ).
Degree: max|Lᵢ|
Number of Gates: g
Total Gate Size: The sum of the circuit complexities of φᵢ.

In terms of tensor circuits, our first main result is the following IOP.

### Theorem 3 (Main IOP Construction). Let

$$ℛ = {ℛ}_{R 1 CS}^{A , B , C , X}$$

be an R1CS relation, where A, B, and C are M×N matrices and X is an n×N matrix.

Suppose that for some constant-dimensional integer vectors k^{(x)}, k^{(y)}, k^{(z)} (possibly of different dimensions), there are isomorphism

$${𝔽}_{2}^{N} ≅ {⊗}_{i} {𝔽}^{{k}_{i}^{( z )}} , and {𝔽}_{2}^{M} ≅ {⊗}_{i} {𝔽}^{{k}_{i}^{( y )}} , and {𝔽}_{2}^{n} ≅ {⊗}_{i} {𝔽}^{{k}_{i}^{( x )}} ,$$

such that when A, B, C, and X are viewed as maps between the corresponding tensor spaces, they each are computable by a constant-degree tensor circuit over [symbol] with g gates, width W, and total gate size S.

Then for all ε>0 there is an IOP for with [symbol] soundness error 2^{-λ} and the following efficiency parameters:
Number of rounds: O(log N).
Prover size: W·g·polylog(λ).
Verifier size: O(λ·S)+poly(λ, M^{ε}, log n), where the polynomial poly is independent of ε, and the verifier is given oracle access to a specific encoding of its input that is computable in time n·polylog(λ).
Queries: The verifier makes O(λ·S) queries to the messages sent by the prover, and O(λ) queries to the encoding of its input.

We will use the IOP of Theorem 3 to construct an efficient argument-system. As discussed in Section 1 this step is non-trivial.

Theorem 4 (Main Interactive Argument Construction). Assume that there exists a sub-exponentially hard collision-resistant hash function computable by linear size circuits mapping λ bits inputs to λ/2 bit outputs.

$$Let ℛ = {ℛ}_{R 1 CS}^{A , B , C , X}$$

be an R1CS relation, where A, B, and C are M×N matrices and X is an n×N matrix.

Suppose that for some constant-dimensional integer vectors k^{(x)}, k^{(y)}, k^{(z)} (possibly of different dimensions), there are isomorphisms

$${𝔽}_{2}^{N} ≅ {⊗}_{i} {𝔽}^{{k}_{i}^{( z )}} , and {𝔽}_{2}^{M} ≅ {⊗}_{i} {𝔽}^{{k}_{i}^{( y )}} , and {𝔽}_{2}^{n} ≅ {⊗}_{i} {𝔽}^{{k}_{i}^{( x )}} ,$$

such that when A, B, C, and X are viewed as maps between the corresponding tensor spaces, they each are computable by a constant-degree tensor circuit over [symbol] with g gates, width W, and total gate size S.

Then, for every ε>0, there is an interactive argument for [symbol] with soundness error 2^{-λ} and the following efficiency parameters:
Number of rounds: O(log N).
Prover size: W·g·polylog(λ)+poly(S, λ)·(N^{ε}+M^{ε}).
Communication complexity: poly(λ, log(W·g)).
Verifier size: poly(λ)·Õ(S+M^{ε}), where the verifier is given oracle access to a specific encoding of its input that is computable by a circuit of size n·polylog(λ).

Finally, we remark that the interactive argument of Theorem 4 can be made zero-knowledge using the standard transformation of Ben-Or et al., The argument can can further be heuristically compiled to a non-interactive argument using the Fiat-Shamir transform.

### 4 IOP Tools

### 4.1 Projectability

Towards constructing |OPs whose queries we can efficiently project (as discussed in Section 1), we state and prove some basic properties of projectability.
Definition 8. If I is a set and q∈ [symbol] , we say that a set [symbol] ⊆I^{q} is projectable if there is a Boolean circuit C of size S=O(|I|) such that for every k∈[q] there is [symbol] ∈[S] such that when C is evaluated on input x∈{0,1}^{I} and (i⁽¹⁾, . . . , i^{(q)})∈ [symbol] , the [symbol] wire of C evaluates to x_{i(q)}.

If [symbol] is a distribution, we say that [symbol] is projectable if the support of [symbol] is projectable.

The following proposition is immediate.

Proposition 1. For every n∈ [symbol] , the set [n] (viewed as I^{q} for I=[n] and q=1) is projectable.
Prefix Projectability. In some of our constructions we will need a stronger property than projectability—namely, that the projection to a set of given prefixes can be efficiently generated. Intuitively, in the context of codewords that belong to a tensor code, prefix-projectability enables us to find rows/columns that are associated with a given set of points.
Definition 9 (Prefix-Projectable Sets and Distributions). Let I₁, . . . , I_{d} be sets of size n₁=|I₁|, . . . , n_{d}=|I_{d}|. Let

$$⊆ {( {\prod }_{i = 1}^{d} {I}_{i} )}^{q}$$

be a set, and for every j∈[d] let λⱼ: I₁× . . . ×I_{d}→I₁× . . . ×Iⱼ denote the projection function that on input (i₁, . . . , i_{d}) outputs the prefix (i₁, . . . , iⱼ).

We say that [symbol] is prefix-projectable if for every j∈[d], there is a binary circuit Cⱼ of size

$$S = O ( {\prod }_{i = 1}^{j} {n}_{i} )$$

(not counting input wires) such that for any k∈[q], there exists [symbol] ∈[S] such that when C is evaluated on input x∈{0, 1}^{I}^{₁}^{× . . . ×I}^{ⱼ} and (λⱼ(i⁽¹⁾), . . . , πⱼ(i^{(q)})) for (i⁽¹⁾, . . . , i^{(q)})∈ [symbol] , the [symbol] wire of C evaluates to

$${x}_{{π}_{j} ( {i}^{( k )} )} .$$

We say that a distribution is prefix-projectable if its support is prefix-projectable.

The following simple proposition shows that if the set contains only a single point then it is prefix projectable.

Proposition 2. Let I₁, . . . , I_{d} be sets and [symbol] be a singleton set

$$= \{ ( {i}^{( 1 )} , ... , {i}^{( q )} ) \} ⊆ {( {\prod }_{i = 1}^{d} {I}_{i} )}^{q} .$$

Then [symbol] is prefix-projectable
The following proposition assists in establishing the projectability of queries to tensor codewords in which the verifier queries the entirety of the rows of a codeword indexed by i₁, . . . , i_{q}. In this case the whole set of verifier's queries can be viewed as a “product” of two prefix-projectable sets: one corresponding to the set of queried rows, and the other corresponding to the set of all columns.

### Fact 3. If

$$⊆ {( {\prod }_{i = 1}^{d} {I}_{i} )}^{q} and {′}^{} ⊆ {( {\prod }_{i = 1}^{{d}^{′}} {I}_{i}^{′} )}^{{q}^{′}}$$

are prefix-projectable, then with [symbol] denoting

$${\prod }_{i = 1}^{d} {I}_{i}$$

and [symbol] denoting

$${\prod }_{i = 1}^{{d}^{′}} {I}_{i}^{′} ,$$

the set

$$( ∘ {′}^{} ) {=}^{def} \{ {( {i}^{( k )} ∘ {j}_{k}^{( ℓ )} )}_{k ∈ [ q ] , ℓ ∈ [ {q}^{′} ]} : ( {i}^{( 1 )} , ... , {i}^{( q )} ) ∈ , \begin{matrix}( {j}_{1}^{( 1 )} , ... , {j}_{1}^{( {q}^{′} )} ) ∈ {′}^{} \\ … \\ ( {j}_{q}^{( 1 )} , ... , {j}_{q}^{( {q}^{′} )} ) ∈ {′}^{}\end{matrix} \} ⊆ {( ℐ \times {ℐ}^{′} )}^{q \cdot {q}^{′}}$$

(where ∘ on the right-hand side denotes concatenation) is prefix-projectable too.
Fact 4. If B₁, . . . , B_{q} are disjoint subsets of I, an [symbol] ⊆B₁× . . . ×B_{q}, then [symbol] is projectable.

### 4.1.1 Projectable Samplers

One of the major building blocks in our IOPs is a method for a verifier to probabilistically query a string such that (1) the queries are projectable and (2) if the string is promised to contain many 1s, the verifier will query many of those 1s. If one simply selects a random subset of the string, then property (2) holds, but we do not know how to guarantee linear-size projectability. Thus, we will instead sample from a slightly different distribution, from which we do know how to project.
Definition 10 (Samplers). We define a (δ, λ)-sampler for I as a distribution [symbol] on I^{q}, where q=O(λ/δ), such that for any string x∈{0,1}^{I} with relative Hamming weight at least δ, it holds except with probability 2^{-λ} when sampling (i₁, . . . , i_{q})← [symbol] that xᵢ_{ⱼ}=1 for at least λ values of j∈[q].
Proposition 3 (Prefix-Projectable Samplers). For every constant t∈ [symbol] , every constant δ>0 and every λ∈ [symbol] , there is a prefix-projectable (δ, λ) sampler for [n]^{t} that is sampleable by a circuit of size

$$O ( \frac{λ \cdot log n}{δ} ) .$$

### 4.2 Encoded IOPs

Definition 11. An encoded-message IOP, wrt an error-correcting code C, is defined exactly like an IOP with the following modifications. As part of the protocol specification, each round is associated with a bit bᵢ. For rounds i for which bᵢ=1, the honest prover must send a codeword from the code C. In the other rounds (i.e., when bᵢ=0), the prover can send arbitrary messages. The soundness condition is relaxed and needs only hold for malicious provers who send codewords from C in every round i for which bᵢ=1 and may send arbitrary messages in the other rounds.
Proposition 4. Let C: [symbol] → [symbol] be a size-S encodable code with constant relative distance and let t≥3 be a constant integer. Then any C^{⊗t}-encoded prefix-projectable IOP Π can be compiled into a standard IOP Π′ with the following parameters:
Soundness Error: ε+2^{-λ}, where ε is the soundness error of Π.
Rounds: same as in Π.
Communication: same as in Π.
Queries: O(q·λ·n²), where q is the query complexity of Π.
Prover Size: same as in Π.
Verifier Size: S_{V}+poly(q,λ,T), where T is the encoding time of C and S_{V} is the verifier size of Π.
Query Projectability: The queries to each codeword are prefix-projectable.

### 4.2.1 Projectability and Encoded IOPs

We say that an IOP has projectable queries if the verifier's query distribution is projectable. We extend this definition to prefix-projectability in the context of encoded IOPs as follows:
Definition 12 (Prefix-Projectable Encoded-Message IOPs). If C⊆ [symbol] is a code (e.g. if C=D^{⊗t} for D⊆ [symbol] ), we say that a C-encoded IOP Π is prefix-projectable if for all i, the queries of the the verifier to the i^{th} encoded message are prefix-projectable. We say that Π is prefix-projectable with respect to its input if the verifier's input is promised to be a tuple of tensor codes, and the verifier's access to each tensor codeword is in the form of prefix-projectable queries.

### 5 Basic IOPs

In this section we build the key sub-protocols that will be used to construct our main IOP. We start, in Section 5.1 with an IOP for checking a local multiplicative relation between codewords (aka the Hadamard check) and then proceed to Section 5.2 in which we give an IOP for checking linear relations.

### 5.1 Hadamard Check

Definition 13. If C is a code, we define Had^{C} to be the promise problem where “yes” instances are triples (C(x), C(y), C(x★y)), and “no” instances are all other triples of codewords of C.
We first construct an IOP for the Had with constant soundness.
Proposition 5 (Constant Soundness Hadamard Check). Let [symbol] be a constructible field extension of [symbol] (2). Let D: [symbol] → [symbol] be a size-S encodable systematic linear code with constant rate and constant relative distance, and define C=D^{⊗t} for some constant integer t.

There is an IOP for Had^{C} with constant soundness error and the following efficiency parameters:
Rounds: O(log S)
Prover size: S·n^{t-1}·polylog(| [symbol] |)
Prover communication: O(n^{t}) elements of [symbol] .
Verifier size: poly(S, log(| [symbol] |)) for some polynomial poly that is independent of t.
Queries: The verifier makes a constant number of queries to its input, and for each prover message m the verifier either reads all of m or makes a constant number of queries to symbols in m. Here we view both the input and the prover messages as strings with alphabet [symbol] .

Our Hadamard check with soundness error 2^{-λ} overhead only works for a more restricted family of codes, which we fortunately are able to construct with polylog(λ) overhead in the encoding size.

Definition 14 ((λ, t)-Hadamard-friendly Codes). We say that a tensor code C over a field [symbol] is (λ, t)-Hadamard-friendly if it has constant rate and constant relative distance and can be written as C=E^{⊗t}⊗M^{⊗t}, where E is any linear code and M is a multiplication code with message space [symbol] and the property that M^{★2} has constant relative distance.
Lemma 1 (Improved Hadamard Check). Let t∈ [symbol] be a constant, and let [symbol] be any constructible field (see Definition 1). Let C⊆ [symbol] be a (λ, t)-Hadamard-friendly tensor code.

There is an IOP for Had^{C} with soundness error 2^{-λ} and the following efficiency parameters:
Rounds: O(log N)
Communication: O(N·log [symbol] )
Prover Size: N·polylog(| [symbol] |)
Verifier Size: O(λ·(λ+log N)+poly(N^{1/t}, log| [symbol] |)), where we emphasize that the degree of the polynomial poly is independent of t.
Queries: O(λ²). These queries are prefix-projectable.
   Encoded-Message IOP for Had^{E⊗t}⊗M^{⊗t} with Soundness Error 2^{-Ω(λ)}

Common Input: Oracle access to triple of codewords cₓ, c_{y}, c_{z}∈C=E^{⊗t}⊗M^{⊗t}
1. The prover computes and sends a codeword

$${c}_{z}^{★} ∈ {E}^{⊗ t} ⊗ {( {M}^{★2} )}^{⊗ t} ,$$

defined so that

$${c}_{z}^{★} ( α , β ) = {c}_{x} ( α , β ) \cdot {c}_{y} ( α , β )$$

for all α∈[k_{E}]^{t} and β∈[n_{M}]^{t}.
2. The verifier samples

$$( {α}_{1} , ... , {α}_{{κ}_{{E}^{⊗ t}}} ) ← {{E}^{⊗ t}}_{}$$

and (β₁, . . . , βₖ_{_{M}}_{⊗t})← [symbol] _{M}_{^{⊗t}}.
3. For each j∈[κ_{E}_{^{⊗t}}], and for all β∈[k_{M}]^{t}, the verifier checks that

$${c}_{z} ( {α}_{j} , β ) = {c}_{z}^{★} ( {α}_{j} , β ) .$$

4. For each j∈[κ_{M}_{^{⊗t}}]:
   (a) Let uⱼ, vⱼ, and wⱼ respectively denote the vector

$${( {c}_{x} ( α , {β}_{j} ) )}_{α ∈ {\vert {k}_{E} \vert}^{t}} , {( {c}_{y} ( α , {β}_{j} ) )}_{α ∈ {\vert {k}_{E} \vert}^{t}} , and {( {c}_{z}^{★} ( α , {β}_{j} ) )}_{α ∈ {\vert {k}_{E} \vert}^{t}} .$$

Let ûⱼ, \hat{v}ⱼ, and ŵⱼ respectively denote

$$\begin{matrix}{E}^{⊗ t} ( {u}_{j} ) = {( {c}_{x} ( α , {β}_{j} ) )}_{α ∈ {\vert {n}_{E} \vert}^{t}} , {E}^{⊗ t} ( {v}_{j} ) = {( {c}_{y} ( α , {β}_{j} ) )}_{α ∈ {\vert {n}_{E} \vert}^{t}} , and \\ {E}^{⊗ t} ( {w}_{j} ) = {( {c}_{z}^{★} ( α , {β}_{j} ) )}_{α ∈ {\vert {n}_{E} \vert}^{t}} .\end{matrix}$$

(b) The prover and verifier, using oracle access to ûⱼ, \hat{v}ⱼ, and ŵⱼ, invoke the constant soundness error IOPP of Proposition 5 on the claim that that wⱼ=uⱼ★vⱼ.

### 5.2 Tensor LinCheck

Definition 15 (Lincheck). If C: [symbol] → [symbol] and C′: [symbol] → [symbol] are linear codes and φ: [symbol] → [symbol] is a linear map, we define Lin^{C,C″,φ} as the promise problem where:
“Yes” instances consist of pairs C(x), C′(φ(x))),
“No” instances consist of pairs (C(x),C′(y)) for y≠φ(x).

We start by describing a basic Lincheck IOP with poor parameters. As a matter of fact, this IOP will not involve the prover or have any interaction. Later, in Lemma 3 we will bootstrap this construction and get an efficient IOP.

Lemma 2 (Basic Lincheck). For any constant t∈ [symbol] , any finite field [symbol] , any systematic linear codes D: [symbol] → [symbol] , D′: [symbol] → [symbol] , and E: [symbol] → [symbol] , and any linear φ:

$${𝔽}^{{k}_{D}^{t}} \to {𝔽}^{{k}_{{D}^{′}}^{t}}$$

that can be implemented by a size-S Boolean circuit, let δ_{E}=Ω(1) denote the relative distance of E, let C denote D^{⊗t}⊗E^{⊗t}, and let C′ denote (D′)^{⊗t}⊗E^{⊗t}.

For λ∈ [symbol] there is an IOP for Lin^{C,C′,φ⊗ID} with soundness error 2^{-λ} and the following efficiency parameters:
Rounds: 0 (there is no prover involvement)
Verifier Size: O(λ·(S+log n_{E})).
Verifier Randomness: O(λ·log n_{E}).
Query Projectability: The verifier makes

$$O ( λ \cdot ( {k}_{D}^{t} + {k}_{{D}^{′}}^{t} ) )$$

O queries to its input, and these queries are prefix-projectable.

### IOP for Lin^{C,C′, φ⊗Id}

Common Input: Oracle access to a pair of codewords cₓ∈C, c_{y}∈C′.
1. Let Q be a prefix-projectable

$$( {δ}_{E}^{t} , λ )$$

sampler for [n_{E}]^{t}. The existence of such a [symbol] is guaranteed by Proposition 3. The verifier samples (i₁, . . . , i_{κ})← [symbol] , where κ=O(λ).
2. For each j∈[κ], let uⱼ denote the vector

$${( {c}_{x} ( α , {i}_{j} ) )}_{α ∈ [ {k}_{D}^{t} ]} ,$$

let vⱼ denote the vector

$${( {c}_{y} ( α , {i}_{j} ) )}_{α ∈ [ {k}_{{D}^{′}}^{t} ]} .$$

The verifier checks that vⱼ=φ(uⱼ).

Lemma 2 admits a generalization to succinct tensor circuits, which is Lemma 3 below.

Definition 16. For an integer t∈ [symbol] and a vector k=(k₁, . . . , k_{d})∈ [symbol] , say C is an ( [symbol] , k, t)-tensor code if C=D⁽¹⁾⊗ . . . ⊗D^{(d)}, where each D⁽ⁱ⁾ has message space [symbol] , and each D⁽ⁱ⁾ is also a t-dimensional tensor code D⁽ⁱ⁾=(E⁽ⁱ⁾)^{⊗t}.
Lemma 3. Let [symbol] be any field, and for any k=(k₁, . . . , k_{d}), let [symbol] denote [symbol] ⊗ . . . ⊗ [symbol] .

For any constant t∈ [symbol] , any k, k′, any ( [symbol] , k, t)-tensor code C, and any ( [symbol] , k′, t)-tensor code C′, and any linear function ϕ: [symbol] → [symbol] that is computable by a tensor circuit with width W, constant degree, and g gates with total size S, there exists an encoded-message IOP for Lin^{C,C′,ϕ} with soundness error 2^{-λ} and the following efficiency parameters:
Rounds: 1 (consisting of g encoded messages)
Communication: O(g·W) elements of [symbol]
Prover Size: O(g·W+S).
Verifier Size: O(λ·(S+g·log W))
Queries: The verifier makes O(λ·S) queries to its input and to the codewords sent by the prover, and these queries are prefix-projectable.
Encoded Messages: For all i, the i^{th} prover message is promised to be a codeword of a tensor code

$${D}_{i}^{⊗ t} .$$

### System Implementations

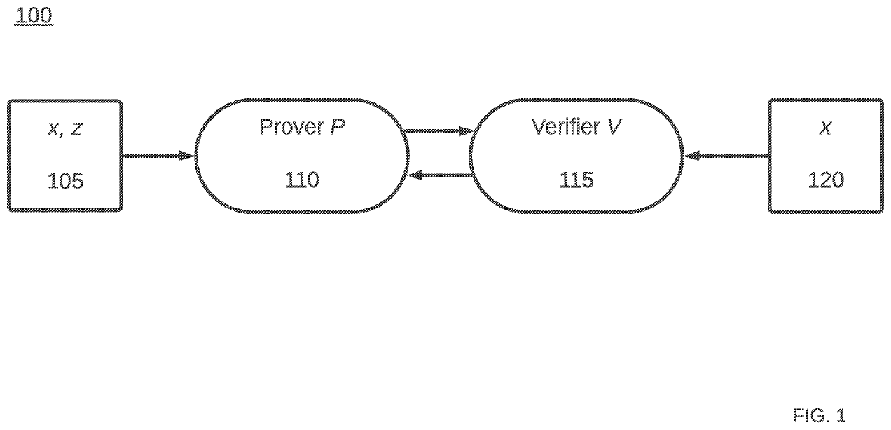

FIG. 1 illustrates an arrangement 100 between a Prover P 110 and Verifier V 115 for implementing various embodiments described and claimed in the present disclosure. As illustrated, Prover 110 has access to x and z, collectively 105, and Verifier has access to x 120. Prover 110 and Verifier 115 can be implemented using any of the computer systems described herein.

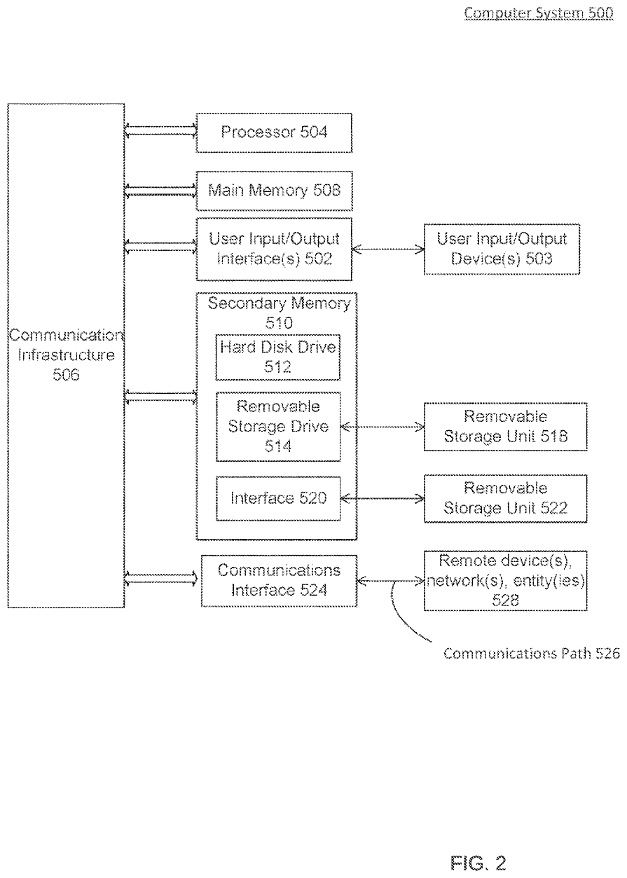

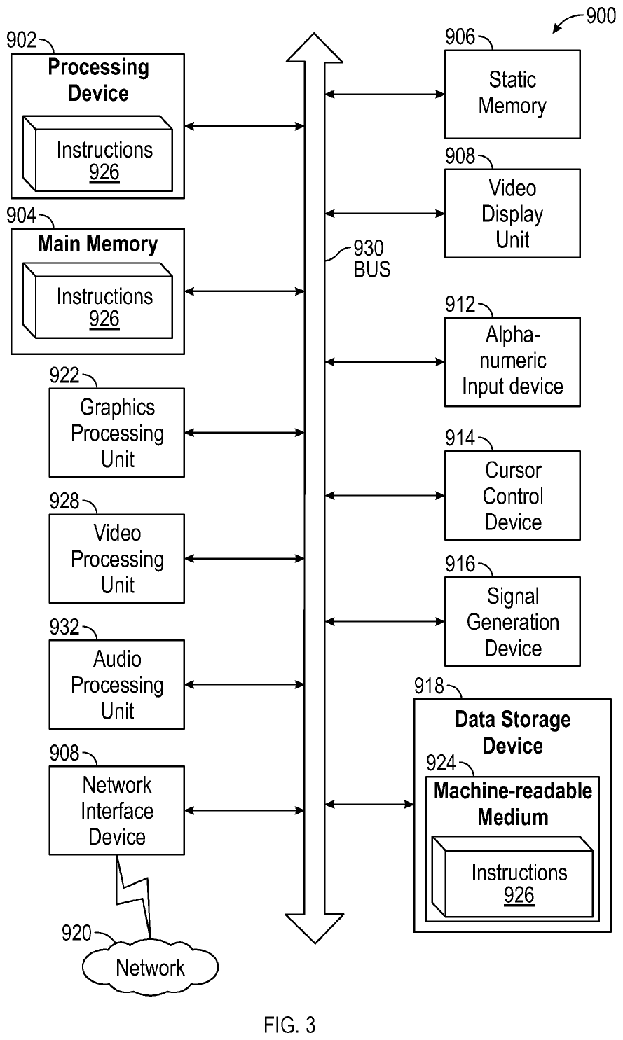

FIGS. 2 and 3 depict example computer systems useful for implementing various embodiments described in the present disclosure. Various embodiments may be implemented, for example, using one or more computer systems, such as computer system 500 shown in FIG. 2. One or more computer system(s) 500 may be used, for example, to implement any of the embodiments discussed herein, as well as combinations and sub-combinations thereof.

Computer system 500 may include one or more processors (also called central processing units, processing devices, or CPUs), such as a processor 504. Processor 504 may be connected to a communication infrastructure 506 (e.g., such as a bus).

Computer system 500 may also include user input/output device(s) 503, such as monitors, keyboards, pointing devices, etc., which may communicate with communication infrastructure 506 through user input/output interface(s) 502. One or more of processors 504 may be a graphics processing unit (GPU). In an embodiment, a GPU may be a processor that is a specialized electronic circuit designed to process mathematically intensive applications. The GPU may have a parallel structure that is efficient for parallel processing of large blocks of data, such as mathematically intensive data common to computer graphics applications, images, videos, etc.

Computer system 500 may also include a main memory 508, such as random-access memory (RAM). Main memory 508 may include one or more levels of cache. Main memory 508 may have stored therein control logic (i.e., computer software, instructions, etc.) and/or data. Computer system 500 may also include one or more secondary storage devices or secondary memory 510. Secondary memory 510 may include, for example, a hard disk drive 512 and/or a removable storage device or removable storage drive 514. Removable storage drive 514 may interact with a removable storage unit 518. Removable storage unit 518 may include a computer-usable or readable storage device having stored thereon computer software (control logic) and/or data. Removable storage drive 514 may read from and/or write to removable storage unit 518.

Secondary memory 510 may include other means, devices, components, instrumentalities, or other approaches for allowing computer programs and/or other instructions and/or data to be accessed by computer system 500. Such means, devices, components, instrumentalities, or other approaches may include, for example, a removable storage unit 522 and an interface 520. Examples of the removable storage unit 522 and the interface 520 may include a program cartridge and cartridge interface, a removable memory chip (such as an EPROM or PROM) and associated socket, a memory stick and USB port, a memory card and associated memory card slot, and/or any other removable storage unit and associated interface.

Computer system 500 may further include communications interface 524 (e.g., network interface). Communications interface 524 may enable computer system 500 to communicate and interact with any combination of external devices, external networks, external entities, etc. (individually and collectively referenced as remote device(s), network(s), entity(ies) 528). For example, communications interface 524 may allow computer system 500 to communicate with external or remote device(s), network(s), entity(ies) 528 over communications path 526, which may be wired and/or wireless (or a combination thereof), and which may include any combination of LANs, WANs, the Internet, etc. Control logic and/or data may be transmitted to and from computer system 500 via communications path 526.

Computer system 500 may also be any of a personal digital assistant (PDA), desktop workstation, laptop or notebook computer, netbook, tablet, smartphone, smartwatch or other wearable devices, appliance, part of the Internet-of-Things, and/or embedded system, to name a few non-limiting examples, or any combination thereof.

Computer system 500 may be a client or server computing device, accessing or hosting any applications and/or data through any delivery paradigm, including but not limited to remote or distributed cloud computing solutions; local or on-premises software (“on-premise” cloud-based solutions); “as a service” models (e.g., content as a service (CaaS), digital content as a service (DCaaS), software as a service (SaaS), managed software as a service (MSaaS), platform as a service (PaaS), desktop as a service (DaaS), framework as a service (FaaS), backend as a service (BaaS), mobile backend as a service (MBaaS), infrastructure as a service (IaaS), etc.); and/or a hybrid model including any combination of the foregoing examples or other services or delivery paradigms.

FIG. 3 illustrates an example machine of a computer system 900 within which a set of instructions, for causing the machine to perform any one or more of the operations discussed herein, may be executed. In alternative implementations, the machine may be connected (e.g., networked) to other machines in a LAN, an intranet, an extranet, and/or the Internet. The machine may operate in the capacity of a server or a client machine in a client-server network environment, as a peer machine in a peer-to-peer (or distributed) network environment, or as a server or a client machine in a cloud computing infrastructure or environment.

The machine may be a personal computer (PC), a tablet PC, a set-top box (STB), a Personal Digital Assistant (PDA), a cellular telephone, a web appliance, a server, a network router, a switch or bridge, a specialized application or network security appliance or device, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 900 includes a processing device 902, a main memory 904 (e.g., read-only memory (ROM), flash memory, dynamic random-access memory (DRAM) such as synchronous DRAM (SDRAM), etc.), a static memory 906 (e.g., flash memory, static random-access memory (SRAM), etc.), and a data storage device 918, which communicate with each other via a bus 930.

Processing device 902 represents one or more processing devices such as a microprocessor, a central processing unit, or the like. More particularly, the processing device may be complex instruction set computing (CISC) microprocessor, reduced instruction set computing (RISC) microprocessor, very long instruction word (VLIW) microprocessor, or processor implementing other instruction sets, or processors implementing a combination of instruction sets. Processing device 902 may also be one or more special-purpose processing devices such as an application-specific integrated circuit (ASIC), a field-programmable gate array (FPGA), a digital signal processor (DSP), network processor, or the like. The processing device 902 is configured to execute instructions 926 for performing the operations and steps discussed herein.

The computer system 900 may further include a network interface device 908 to communicate over the network 920. The computer system 900 also may include a video display unit 910, an alphanumeric input device 912 (e.g., a keyboard), a cursor control device 914 (e.g., a mouse), a graphics processing unit 922, a signal generation device 916 (e.g., a speaker), graphics processing unit 922, video processing unit 928, and audio processing unit 932.

The data storage device 918 may include a machine-readable medium 924 (also known as a computer-readable storage medium) on which is stored one or more sets of instructions 926 (e.g., software instructions) embodying any one or more of the operations described herein. The instructions 926 may also reside, completely or at least partially, within the main memory 904 and/or within the processing device 902 during execution thereof by the computer system 900, where the main memory 904 and the processing device 902 also constitute machine-readable storage media.

In an example, the instructions 926 include instructions to implement operations and functionality corresponding to the disclosed subject matter. While the machine-readable storage medium 924 is shown in an example implementation to be a single medium, the term “machine-readable storage medium” should be taken to include a single medium or multiple media (e.g., a centralized or distributed database, and/or associated caches and servers) that store the one or more sets of instructions 926. The term “machine-readable storage medium” shall also be taken to include any medium that is capable of storing or encoding a set of instructions 926 for execution by the machine and that cause the machine to perform any one or more of the operations of the present disclosure. The term “machine-readable storage medium” shall accordingly be taken to include, but not be limited to, solid-state memories, optical media, and magnetic media.

Some portions of the detailed description have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “identifying” or “determining” or “executing” or “performing” or “collecting” or “creating” or “sending” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage devices.

The present disclosure also relates to an apparatus for performing the operations herein. This apparatus may be specially constructed for the intended purposes, or it may comprise a computer selectively activated or reconfigured by a computer program stored in the computer. Such a computer program may be stored in a computer-readable storage medium, such as but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The operations and illustrations presented herein are not inherently related to any particular computer or other apparatus. Various types of systems may be used with programs in accordance with the teachings herein, or it may prove convenient to construct a more specialized apparatus to perform the operations. The structure for a variety of these systems will appear as set forth in the description herein. In addition, the present disclosure is not described with reference to any particular programming language. It will be appreciated that a variety of programming languages may be used to implement the teachings of the disclosure as described herein.

The present disclosure may be provided as a computer program product, or software, that may include a machine-readable medium having stored thereon instructions, which may be used to program a computer system (or other electronic devices) to perform a process according to the present disclosure. A machine-readable medium includes any mechanism for storing information in a form readable by a machine (e.g., a computer). For example, a machine-readable (e.g., computer-readable) medium includes a machine (e.g., a computer) readable storage medium such as read-only memory (“ROM”), random access memory (“RAM”), magnetic disk storage media, optical storage media, flash memory devices, etc.

In some embodiments, a tangible, non-transitory apparatus or article of manufacture comprising a tangible, non-transitory computer useable or readable medium having control logic (software) stored thereon may also be referred to herein as a computer program product or program storage device. This includes, but is not limited to, computer system 500, main memory 508, secondary memory 510, and removable storage units 518 and 522, as well as tangible articles of manufacture embodying any combination of the foregoing. Such control logic, when executed by one or more data processing devices (such as computer system 500), may cause such data processing devices to operate as described herein.

Based on the teachings contained in this disclosure, it will be apparent to persons skilled in the relevant art(s) how to make and use embodiments of this disclosure using data processing devices, computer systems, and/or computer architectures other than that shown in FIGS. 2 and 3. In particular, embodiments can operate with software, hardware, and/or operating system implementations other than those described herein.

It is to be appreciated that the Detailed Description section, and not any other section, is intended to be used to interpret the claims. Other sections can set forth one or more but not all exemplary embodiments as contemplated by the inventor(s), and thus, are not intended to limit this disclosure or the appended claims in any way.

While this disclosure describes exemplary embodiments for exemplary fields and applications, it should be understood that the disclosure is not limited thereto. Other embodiments and modifications thereto are possible and are within the scope and spirit of this disclosure. For example, and without limiting the generality of this paragraph, embodiments are not limited to the software, hardware, firmware, and/or entities illustrated in the figures described herein. Further, embodiments (whether or not explicitly described herein) have significant utility to fields and applications beyond the examples described herein.

Embodiments have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. Also, alternative embodiments can perform functional blocks, steps, operations, methods, etc. using orderings different than those described herein.

References herein to “one embodiment,” “an embodiment,” “an example embodiment,” or similar phrases, indicate that the embodiment described can include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other embodiments whether or not explicitly mentioned or described herein. Additionally, some embodiments can be described using the expression “coupled” and “connected” along with their derivatives. These terms are not necessarily intended as synonyms for each other. For example, some embodiments can be described using the terms “connected” and/or “coupled” to indicate that two or more elements are in direct physical or electrical contact with each other. The term “coupled,” however, can also mean that two or more elements are not in direct contact with each other, but yet still co-operate or interact with each other.

The breadth and scope of this disclosure should not be limited by any of the above-described exemplary embodiments but should be defined only in accordance with the following claims and their equivalents. In the foregoing specification, implementations of the disclosure have been described with reference to specific example implementations thereof. It will be evident that various modifications may be made thereto without de-parting from the broader spirit and scope of implementations of the disclosure as set forth in the following claims. The specification and drawings are, accordingly, to be regarded in an illustrative sense rather than a restrictive sense.

1. A method for certifying that a computation of at least one executable instruction is performed correctly at a computerized processor, the method comprising:
receiving an algorithmic representation of a computation to be verified, the computation being of a type;
receiving a desired soundness error parameter;
translating the computation into a matrix representation including matrices A, B, C, X, each of which is a sum of tensor products of a constant number of smaller matrices;
wherein the matrices A, B, C, X represent the computation;
wherein part of a description of the matrices includes a decomposition of the matrices;
both a verifier and a prover storing an input string x, wherein x is dependent on or associated with the type of computation;
storing at the prover an input string z, wherein x and z are related to each other by X·z=x, wherein · denotes matrix-vector multiplication, and a pointwise Hadamard product of (A·z) and (B·z) is (C·z);
executing a protocol by:
1. at the prover, computing and transmitting digests of z, A·z, B·z, C·z;
2. for each constraint a′=A·z′, b′=B·z′, c′=C·z′, x′=X·z′, and the constraint that c′ is the pointwise Hadamard product of a′ and b′, and wherein z′, a′, b′, c′ denote the values of which the prover transmitted digests:
executing a sub-protocol, the sub-protocol comprising:
a. at the verifier:
i. representing the constraint as multiple smaller constant-degree constraints, each of the smaller constraints involving a constant number of intermediate vectors;
ii. deriving from each of these smaller constraints multiple extended constraints, of the same form, on a linear encoding of the intermediate vectors with a property of:
1. if the constraint was satisfied, then all of these extended constraints can be satisfied;
2. otherwise, at most a constant fraction of them can be satisfied;
b. at the prover:
i. transmitting to the verifier encodings of the intermediate vectors;
c. at the verifier:
i. for each of the smaller linear constraints, uniformly sampling multiple derived extended constraints; and
ii. checking that each of the sampled derived extended constraints is satisfied; and
3. at the verifier, outputting a positive result if and only if the checking that each of the sampled derived extended constraints is satisfied.

2. The method of claim 1, wherein the prover transmits a compressed version of each message, and at the verifier, verifier accesses to the uncompressed messages are replaced by a local opening protocol between the prover and the verifier.

3. The method of claim 2, wherein the compressed version is compressed by a succinct vector commitment or a hash tree.

4. The method of claim 1, further comprising the intermediate vectors are specified as:
z₀=z, z₁, . . . , zₘ=a such that, where each constraint either has the form:
zᵢ=zⱼ+zₖ for some integers i, j, k between 0 and m inclusive; or
zᵢ=Aᵢ·zⱼ for a matrix Aᵢ that is a tensor product of identity matrices with one of the smaller matrices comprising A.

5. The method of claim 1, wherein the prover is possibly dishonest.

6. A system for certifying that a computation of at least one executable instruction is performed correctly at a computerized processor, the system comprising a computer processor configured for executing instructions for: receiving an algorithmic representation of a computation to be verified, the computation being of a type;
receiving a desired soundness error parameter;
translating the computation into a matrix representation including matrices A, B, C, X, each of which is a sum of tensor products of a constant number of smaller matrices;
wherein the matrices A, B, C, X represent the computation;
wherein part of a description of the matrices includes a decomposition of the matrices;
both a verifier and a prover storing an input string x, wherein x is dependent on or associated with the type of computation;
storing at the prover an input string z, wherein x and z are related to each other by X·z=x, wherein · denotes matrix-vector multiplication, and a pointwise Hadamard product of (A·z) and (B·z) is (C·z);
executing a protocol by:
1. at the prover, computing and transmitting digests of z, A·z, B·z, C·z;
2. for each constraint a′=A·z′, b′=B·z′, c′=C·z′, x′=X·z′, and the constraint that c′ is the pointwise Hadamard product of a′ and b′, and wherein z′, a′, b′, c′ denote the values of which the prover transmitted digests:
executing a sub-protocol, the sub-protocol comprising:
a. at the verifier:
i. representing the constraint as multiple smaller constant-degree constraints, each of the smaller constraints involving a constant number of intermediate vectors;
ii. deriving from each of these smaller constraints multiple extended constraints, of the same form, on a linear encoding of the intermediate vectors with a property of:
1. if the constraint was satisfied, then all of these extended a constraints can be satisfied;
2. otherwise, at most a constant fraction of them can be satisfied;
b. at the prover:
i. transmitting to the verifier encodings of the intermediate vectors;
c. at the verifier:
i. for each of the smaller linear constraints, uniformly sampling multiple derived extended constraints; and
ii. checking that each of the sampled derived extended constraints is satisfied; and
3. at the verifier, outputting a positive result if and only if the checking that each of the sampled derived extended constraints is satisfied.

7. The system of claim 6, wherein the prover transmits a compressed version of each message, and at the verifier, verifier accesses to the uncompressed messages are replaced by a local opening protocol between the prover and the verifier.

8. The system of claim 7, wherein the compressed version is compressed by a succinct vector commitment or a hash tree.

9. The system of claim 6, further comprising the intermediate vectors are specified as:
z₀=z, z₁, . . . , zₘ=a such that, where each constraint either has the form:
zᵢ=zⱼ+zₖ for some integers i, j, k between 0 and m inclusive; or
as zᵢ=Aᵢ·zⱼ for a matrix Aᵢ that is a tensor product of identity matrices with one of the smaller matrices comprising A.

10. The system of claim 6, wherein the prover is possibly dishonest.

11. The method of claim 1, wherein the linear encoding of the intermediate vectors is performed using a Reed-Solomon code over a finite field [symbol] of size O(λ), where λ is a security parameter.

12. The method of claim 1, wherein the matrices A, B, C, and X are represented as tensor circuits over [symbol] with g gates, width W, and total gate size S, and wherein the prover size is W·g·polylog(λ) and the verifier size is O(λ·S)+poly(λ, M^{ε}, log n), where M is the number of rows in matrices A, B, and C, n is the number of rows in matrix X, and ε>0 is a constant.

13. The method of claim 1, wherein the protocol has O(log N) rounds of interaction between the prover and the verifier, where N is the number of columns in matrices A, B, C, and X.

14. The system of claim 6, wherein the linear encoding of the intermediate vectors is performed using a Reed-Solomon code over a finite field [symbol] of size O(λ), where λ is a security parameter.

15. The system of claim 6, wherein the matrices A, B, C, and X are represented as tensor circuits over [symbol] with g gates, width W, and total gate size S, and wherein the prover size is W·g·polylog(λ) and the verifier size is O(λ·S)+poly(λ, M^{ε}, log n), where M is the number of rows in matrices A, B, and C, n is the number of rows in matrix X, and ε>0 is a constant.

16. The system of claim 6, wherein the protocol has O(log N) rounds of interaction between the prover and the verifier, where N is the number of columns in matrices A, B, C, and X.

17. A non-transitory computer-readable storage medium storing instructions that, when executed by a processor, cause the processor to perform a method for certifying that a computation of at least one executable instruction is performed correctly at a computerized processor, the method comprising:
receiving an algorithmic representation of a computation to be verified, the computation being of a type;
receiving a desired soundness error parameter;
translating the computation into a matrix representation including matrices A, B, C, X, each of which is a sum of tensor products of a constant number of smaller matrices;
wherein the matrices A, B, C, X represent the computation;
wherein part of a description of the matrices includes a decomposition of the matrices;
both a verifier and a prover storing an input string x, wherein x is dependent on or associated with the type of computation;
storing at the prover an input string z, wherein x and z are related to each other by X·z=x, wherein · denotes matrix-vector multiplication, and a pointwise Hadamard product of (A·z) and (B·z) is (C·z);
executing a protocol by:
1. at the prover, computing and transmitting digests of z, A·z, B·z, C·z;
2. for each constraint a′=A·z′, b′=B·z′, c′=C·z′, x′=X·z′, and the constraint that c′ is the pointwise Hadamard product of a′ and b′, and wherein z′, a′, b′, c′ denote the values of which the prover transmitted digests:
executing a sub-protocol, the sub-protocol comprising:
1. at the verifier:
(a) representing the constraint as multiple smaller constant-degree constraints, each of the smaller constraints involving a constant number of intermediate vectors;
(b) deriving from each of these smaller constraints multiple extended constraints, of the same form, on a linear encoding of the intermediate vectors with a property of:
i. if the constraint was satisfied, then all of these extended constraints can be satisfied;
ii. otherwise, at most a constant fraction of them can be satisfied;
2. at the prover:
(a) transmitting to the verifier encodings of the intermediate vectors;
3. at the verifier:
(a) for each of the smaller linear constraints, uniformly sampling multiple derived extended constraints; and
a (b) checking that each of the sampled derived extended constraints is satisfied; and
4. at the verifier, outputting a positive result if and only if the checking that each of the sampled derived extended constraints is satisfied.

18. The non-transitory computer-readable storage medium of claim 17, wherein the prover transmits a compressed version of each message, and at the verifier, verifier accesses to the uncompressed messages are replaced by a local opening protocol between the prover and the verifier.

19. The non-transitory computer-readable storage medium of claim 18, wherein the compressed version is compressed by a succinct vector commitment or a hash tree.

20. The non-transitory computer-readable storage medium of claim 17, wherein the intermediate vectors are specified as:
z₀=z, z₁, . . . , zₘ=a such that, where each constraint either has the form:
zᵢ=zⱼ+zₖ for some integers i, j, k between 0 and m inclusive; or
zᵢ=Aᵢ·zⱼ for a matrix Aᵢ that is a tensor product of identity matrices with one of the smaller matrices comprising A.
